(19) United States
(12) Patent Application Publication
(10) Pub. No.: US 2026/0111170 A1
(43) Pub. Date: Apr. 23, 2026

(54) METHODS OF COMMUNICATING AUDIO DATA AND RELATED APPARATUS

(71) Applicant: SOCIAL MICROPHONE, INC., Palo Alto, CA (US)

(72) Inventors: Uwe KUMMEROW, MARL (DE); Kenneth Nathaniel SHERMAN, Montecito, CA (US)

(21) Appl. No.: 19/469,552

(22) PCT Filed: Aug. 22, 2024
(86) PCT No.: PCT/US2024/043494

§ 371 Date: Sep. 26, 2025

Related U.S. Application Data
(60) Provisional application No. 63/534,061, filed on Aug. 22, 2023.

(51) Int. Cl. G06F 3/16

(52) U.S. Cl. CPC G06F 3/165; G06F 3/162

(57) ABSTRACT

The methods of communicating audio data disclosed herein decouple the generating audio data by an audio source from sending the audio data over a network cloud by a sending side network hardware abstraction layer by using a thread pool. The thread pool decouples the generation of the audio data from the sending of the audio data thereby preventing network delays from impacting audio data generation. The methods decouple the receiving of the audio data from the network cloud by pulling the audio data through at least portions of the receiving side thereby delivering precise quantities of audio data at precise times to an audio device. The data requirements of the audio device control the flow of audio data through the receiving side, not the receiving of audio data from the network cloud.

### CROSS-REFERENCE TO RELATED APPLICATIONS

This application claims priority and benefit of U.S. Provisional Patent Application No. 63/534,061 filed 22 Aug. 2023, which is hereby incorporated by reference in its entirety herein.

### BACKGROUND OF THE INVENTION

### Field

This disclosure relates to network communication of data, and, in particular, to methods and related apparatus for communicating audio data from an audio source to an audio device via the network cloud to be utilized by the audio device in real time.

### Background

It may be desirable to communicate audio data in digital form from an audio source through a network cloud to an audio device that may then utilize the audio data in real time. For example, the audio device may broadcast the audio data in humanly perceptible form (e.g., generate humanly perceptible sound) in real time. However, certain problems arise in broadcasting audio data from the audio output device in real time wherein the audio data is received from the audio source via the network cloud. For example, unstable events on a sending side result in unstable transmission of audio from the audio source to the network cloud. As another example, unstable timing between receiving audio data from the network cloud and utilizing of the audio data by the audio device may result in unstable operation of the audio device. For example, the sounds may become unstable (e.g., unintelligible). Such systems may feed a jitter buffer by incoming network events and act on packet loss or packet bursts when it's happening resulting in a fluctuating latency depending on the network quality. Network buffer overrunning may result in the return of echo that had been cancelled earlier. While this example discusses broadcasting of audio data from the audio device, various other utilizations of the audio data by the audio device may require stable communication of audio data in digital form from the audio source through a network cloud to the audio device.

Accordingly, there is a need for improved methods and related apparatus and compositions of matter for communicating audio data from an audio source to an audio device via the network cloud for utilization by the audio device in real time.

### BRIEF SUMMARY OF THE INVENTION

These and other needs and disadvantages may be overcome by the methods and related apparatus and compositions of matter disclosed herein. Additional improvements and advantages may be recognized by those of ordinary skill in the art upon study of the present disclosure.

The methods of communicating audio data disclosed herein include the step of generating audio data indicative of an audio signal by an audio source included in an audio hardware abstraction layer, and the step of generating an event by filling an audio buffer with audio data from the audio source, the audio buffer included in the audio hardware abstraction layer, in various aspects. The methods may include the step of triggering a thread of a thread pool by the event, the thread transferring the audio data from the audio hardware abstraction layer to a sending side network hardware abstraction layer, the thread pool decoupling the audio hardware abstraction layer from the sending side network hardware abstraction layer. The methods may include the step of sending the audio data as data packets from the sending side network hardware abstraction layer to a network cloud.

The methods of communicating audio data disclosed herein include the step of receiving data packets incoming from the network cloud by a receiving side network hardware abstraction layer and the step of pushing data packets from the receiving side network hardware abstraction layer to an audio output hardware abstraction layer, in various aspects. In various aspects, the methods include the step of pulling audio data by an audio device from the audio output hardware abstraction layer, thereby generating a synchronization event, and the step of using the synchronization event in controlling pulling of audio data through the audio output hardware abstraction module thereby making audio data available for pulling by the audio device as required by the audio device.

Related audio communication systems that implement at least some of the steps of the methods of communicating audio data are disclosed herein. At least portions of the methods of communicating audio data and related audio communication systems may be implemented by computer including hardware and operable software associated therewith. Compositions of matter in the form of non-transitory computer readable media comprising computer readable instructions that, when executed, cause one or more computers to function as at least portions of the audio communication systems or to implement at least some of the method steps of the methods of communicating audio data are disclosed herein. At least portions of the methods of communicating audio data, the audio communication systems, and the compositions of matter may be implemented in the cloud or in a distributed computing environment, in various aspects.

This summary is presented to provide a basic understanding of some aspects of the methods and apparatus disclosed herein as a prelude to the detailed description that follows below. Accordingly, this summary is not intended to identify key elements of the methods, apparatus, and compositions of matter disclosed herein or to delineate the scope thereof.

### BRIEF DESCRIPTION OF THE DRAWINGS

FIG. 1 illustrates by schematic diagram an exemplary implementation of an audio communication system in accordance with the present inventions;

FIG. 2A illustrates by schematic diagram portions of the exemplary implementation of an audio communication system of FIG. 1;

FIG. 2B illustrates by schematic diagram portions of the exemplary implementation of an audio communication system of FIG. 1;

FIG. 3 illustrates by Rummler-Brache diagram exemplary operations of the exemplary implementation of an audio communication system of FIG. 1;

FIG. 4A illustrates by Rummler-Brache diagram exemplary operations of a sending side of the exemplary implementation of an audio communication system of FIG. 1; and,

FIG. 4B illustrates by Rummler-Brache diagram exemplary operations of a receiving side of the exemplary implementation of an audio communication system of FIG. 1.

The Figures are exemplary only, and the implementations illustrated therein are selected to facilitate explanation. For example, the components of various systems illustrated in the Figures may be selected for explanatory purposes, and the components may be grouped in the Figures in various ways to facilitate description, so that the systems may include various other components or the components may be grouped in various other ways, in other implementations. The method steps of the various methods illustrated in the Figures may be performed, for example, in other orders or the method steps may be divided or subdivided in various ways, in other implementations. Information flows and process flows in the Figures included herein are indicated by arrows, and it should be understood that additional information flows may occur between various components and that additional process flows may occur, in various other implementations. Where used in the various Figures, the same numerals designate the same or similar elements. Use herein of relative terms such as generally, about, approximately, essentially, may be indicative of engineering, manufacturing, or scientific tolerances such as ±0.1%, ±1%, ±2.5%, ±5%, or other such tolerances, as would be recognized by those of ordinary skill in the art upon study of this disclosure. The Figures including the systems, methods, and compositions of matter illustrated therein are not to be considered limiting unless expressly so stated.

### DETAILED DESCRIPTION OF THE INVENTION

Methods for communicating audio data from an audio source to an audio device via a network cloud and related audio communication systems and compositions of matter are disclosed herein. In various aspects, the audio source is disposed on a sending side of the network cloud and the audio device is disposed on a receiving side of the network cloud.

In various aspects, the methods decouple the generating of audio data by the audio source from the sending of the audio data over the network cloud on the sending side. This decoupling may eliminate unstable events on the sending side that cause instabilities in the sending of audio data from the audio source to the network cloud, and thence, to an audio device. For example, this decoupling may prevent network cloud transmission delays from blocking the generation of audio data by the audio source. That is, for example, network cloud delays do not propagate back to the audio source because of the decoupling.

The methods control the flow of data through at least portions of the receiving side using a synchronization event generated by the pulling of audio data by the audio device and a timing event indicative of a rate at which audio data is being received from the network cloud, in various aspects. Thus, data flow of audio data through at least portions of the receiving side is controlled by the rate at which audio data is being pulled by the audio device (e.g., the rate is controlled by the audio device), not the rate at which data is being received from the network cloud, thereby resulting in stable flow of audio data through at least portions of the receiving side to the audio device. Accordingly, the methods may resolve problems caused by unstable timing between receipt of audio data from the network cloud and use of the audio data by the audio device. For example, precisely controlling the rate at which audio data is flowed through the receiving side may facilitate processing of the audio data such as echo cancellation on the receiving side and may maintain stability in utilization of the audio data by the audio device. The methods disclosed herein may allow handling of echo re-movement when the audio source is in the same room as the audio device. Methods disclosed herein provide constant latency in live events independent of network fluctuations.

A computer may be configured to implement at least a portion of the methods and related apparatuses and compositions of matter on the sending side, and another computer may be configured to implement at least a portion of the methods and related apparatuses and compositions of matter on the receiving side, in certain aspects. Both the sending side and the receiving side may be implemented by the same computer, for example, in other aspects, such as those directed to voice over internet protocol (VoIP). Compositions of matter are disclosed herein in the form of non-transitory computer readable media comprising computer readable instructions that, when executed, cause one or more computers to function as at least portions of the apparatus or to implement at least some of the method steps of the methods.

Software including computer readable instructions, as used herein, may be, for example, in the form of high-level code such as C or Java, or may be in the form of machine code. In some aspects, software may execute on one computer. In other aspects, two or more computers may communicate with one another via network, and the software may be organized in various ways such that portions of the software may be distributed operatively over the two or more computers to be executed by the two or more computers. Although generally described as implemented by software, the methods disclosed herein may be implemented in hardware or in a combination of hardware and software, in various aspects. As would be recognized by those of ordinary skill in the art upon study of this disclosure, the methods, apparatus, and compositions of matter disclosed herein may be practiced in distributed computing environments where certain tasks are performed by processors and data storage distributed in the network cloud. A nominal representation of data may either be the data itself or a pointer, description, or other data that may be used to create the data.

As used herein, a processor is an electronic circuit that performs operations on data such as, for example, arithmetical operations, logical operations, and input/output (I/O) operations. A computer, as used herein, includes a one or more processors, and may, in various aspects, include memory, display, microphone, speaker, mouse, keyboard, storage device(s), I/O devices, network interface, and so forth. Computer may include, for example, single-processor or multiprocessor computers, minicomputers, mainframe computers, as well as personal computers, hand-held computing devices, mobile devices, cellular telephones, tablets, watches, and other processor-based devices, as would be readily recognized by those of ordinary skill in the art upon study of this disclosure. Computer may include one or more processors or processes distributed in a network cloud, in various aspects.

Network cloud, cloud, or network, as used herein, includes, for example, the Internet, local area networks (LAN), cell phone networks (e.g., 4G, 5G), text messaging networks (such as MMS or SMS networks), wide area networks (WAN), and combinations thereof. Data may be communicated through the network cloud by various wired and wireless technologies and combinations of wired and wireless technologies. The network cloud may include, for example, processors, data storage devices, input/output devices, computers, servers, routers, amplifiers, wireless transmitters, wireless receivers, optical devices, virtualized resources, and so forth, as would be readily recognized by those of ordinary skill in the art upon study of this disclosure.

Audio data is a binary representation of a sound such as a human voice, musical instrument(s), or other such vibration that propagates as an acoustic wave, in various aspects. In certain aspects, the audio data may include data packets configured for network transmission. The data packets may include both control information and payload configured in various ways, as would be readily recognized by those of ordinary skill in the art upon study of this disclosure.

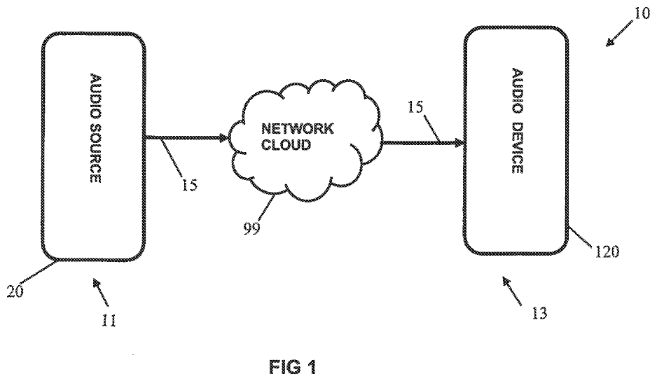

FIG. 1 illustrates an exemplary audio communication system 10 including audio source 20 in communication with audio device 120 via network cloud 99 to communicate audio data 15 from audio source 20 to audio device 120 via network cloud 99. Audio source is configured to generate audio data 15. Accordingly, in some implementations, audio source 20 may include a microphone configured to capture sounds in analog form or digital form. Audio source 20 then digitizes the sounds thereby forming audio data 15, in such implementations. Thus, audio data 15 may, for example, include digital representations of sounds captured contemporaneously by audio source 20 such as spoken words and music. Audio data 15 may include digital representations of physiologically generated sounds such as, for example, heart beats, respiration, and digestive sounds such as peristaltic contractions. In various implementations, the audio data 15 being transmitted may generally represent a full sound spectrum ranging from low frequencies to high (ultrasonic) frequencies and may be transmitted losslessly so that information is not lost through compression between audio source 20 and audio device 120. Audio device 120 may then analyze audio data 15 in order to detect a medical condition such as, for example, cardiac, digestive, and cognitive pathologies. Audio device 120 may employ various artificial intelligence (e.g., large language model) technologies in order to detect the medical condition using audio data 15. As further examples, audio data 15 may include natural sounds for the detection of natural phenomena and sounds associated with machinery for the detection of mechanical defects.

In other implementations, audio data 15 may be include digital representation(s) of sounds captured at some earlier time, stored, for example, using digital storage media in a digital format such as mp4 format, and then input via audio source 20. As another example, audio data 15 may include a digital representation of sounds stored in analog form (e.g., a phonograph recording, a magnetic tape recording). Because audio data 15 may be contemporaneous, may be from some earlier time, or may be both contemporaneous and from some earlier time, real time in the context of audio communication system 10 refers to utilization of audio data 15 by audio device 120 generally contemporaneously with communication of audio data 15 from audio source 20.

Audio device 120 may be generally any device utilizing audio data that requires precise delivery of reassembled audio data 15. For example, in some implementations, audio device 120 may broadcast the audio data 15 in a humanly perceptible form. In such implementations, audio device 120 may include an amplifier(s), speaker(s), etc. and associated operable software. Audio data is delivered with precision to such an audio device in order to ensure that the broadcast replicates the audio data 15 as generated by the audio source 20 and is free of distortions, noise, and is otherwise intelligible.

In other implementations, audio device 120 may utilize the audio data 15 by further processing the audio data. For example, audio device 120 may utilize the audio data in performing speech recognition, speech transcription, language translation, or speech correction. Audio device 120 may be implemented, at least in part, using artificial intelligence (AI), and audio device 120 may be implemented, at least in part, in the cloud. Audio device 120 may be virtual, physical, or both virtual and physical, in various implementations.

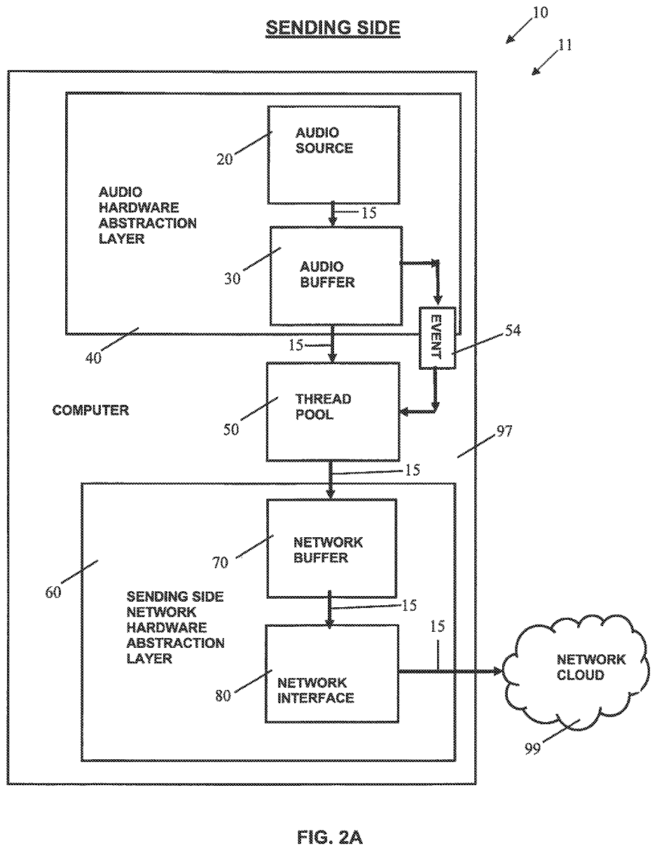

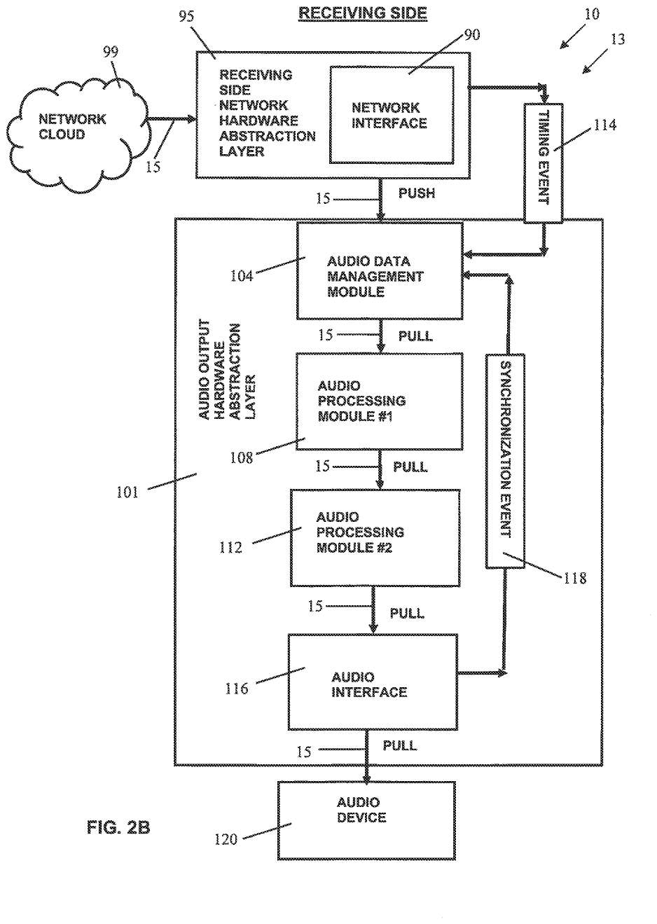

FIG. 2A illustrates sending side 11 of exemplary audio communication system 10 including audio hardware abstraction layer 40, thread pool 50, and sending side network hardware abstraction layer 60 that cooperate to communicate audio data 15 from audio source 20 to network cloud 99. Sending side 11 of exemplary audio communication system 10 including audio hardware abstraction layer 40, thread pool 50, and sending side network hardware abstraction layer 60 comprise portions of computer 97, in this implementation.

Audio hardware abstraction layer 40, as illustrated, includes audio source 20 and audio buffer 30, with audio buffer 30 cooperating with audio source 20 to store audio data 15 from audio source 20 as audio data 15 is being generated. Audio hardware abstraction layer 40, in this implementation, includes a software layer and a hardware layer in operable cooperation with one another. The software layer may be operable to support and control audio source 20 and audio buffer 30, and the software layer may provide an application programming interface (API) to access audio source 20, audio buffer 30, and audio data 15. The software layer may be formed as portions of an operating system, firmware, or combinations thereof, of computer 97, in various implementations. The hardware layer may include hardware supporting audio source 20 and audio buffer 30, and the hardware layer may include hardware supporting the software layer. The hardware layer may include a processor, an A/D converter to digitize analog sounds captured by the microphone, memory, and suchlike, as would be readily recognized by those of ordinary skill in the art upon study of this disclosure. Portions of the hardware of computer 97 may form the hardware layer, in this implementation. While sending side 11 is illustrated as implemented by computer 97, in this implementation, it should be recognized that at least portions of sending side 11 may be implemented in the cloud, in a distributed computing environment, or in other ways, in various other implementations.

Sending side network hardware abstraction layer 60, as illustrated in FIG. 2A, includes network interface 80 and network buffer 70, with network buffer 70 cooperating with network interface 80 to store audio data 15 for communication with network cloud 99. Sending side network hardware abstraction layer 60, in this implementation, includes a software layer and a hardware layer in operable cooperation with one another. The hardware layer includes network interface 80, and network interface 80 includes hardware that implements network communication. The hardware layer may include other hardware that supports network interface 80 and the software layer.

The software layer may be operable to support and control the hardware layer including network interface 80 and network buffer 70. The software layer may be formed as portions of an operating system, firmware, combinations thereof, of computer 97, in this implementation.

Sending side network hardware abstraction layer 60 including the hardware layer and the software layer may be configured to implement, for example, Ethernet (IEEE 802.3), wireless (IEEE 802.11), Bluetooth, 5G, or other wired or wireless communication with network cloud 99, as would be readily recognized by those of ordinary skill in the art upon study of this disclosure. Sending side network hardware abstraction layer 60 may include an API to communicate audio data 15 with network interface 80 including network buffer 70 and to control data communications with network cloud 99. Audio data 15 may be communicated with network cloud 99 in the form of data packets by sending side network hardware abstraction layer 60.

As illustrated in FIG. 2A, audio hardware abstraction layer 40 communicates audio data 15 with sending side network hardware abstraction layer 60 via thread pool 50. Thread pool 50 maintains multiple threads waiting for tasks to be allocated for concurrent execution. The number of threads in thread pool 50 may depend upon the number of processors. Four processors, for example, are required to support a thread pool, such as thread pool 50, having four threads. As an example, the Apple iphone 12 uses an Apple A14 Bionic system on a chip having 6 processors (cores) that, accordingly, may implement a thread pool, such as thread pool 50, having 6 threads. It has been observed in certain implementations that 2 threads is generally sufficient.

FIG. 2B illustrates receiving side 13 of exemplary audio communication system 10 includes receiving side network hardware abstraction layer 95, audio output hardware abstraction layer 101, and audio device 120 that cooperate to receive audio data 15 from network cloud 99 and communicate the audio data 15 so received to audio device 120. In various implementations, receiving side 13 of exemplary audio communication system 10 including receiving side network hardware abstraction layer 95, audio output hardware abstraction layer 101, and audio device 120 may comprise portions of a computer, such as computer 97. At least portions of receiving side 13 may be implemented in the cloud, in hardware, in a distributed computing environment, or in other ways, in various implementations.

Receiving side network hardware abstraction layer 95, as illustrated in FIG. 2A, includes network interface 90 that communicates with network cloud 99. Receiving side network hardware abstraction layer 95, in this implementation, includes a software layer and a hardware layer in operable cooperation with one another. The hardware layer includes network interface 90 that includes hardware to implement network communication, and the hardware layer may include other hardware that supports network interface 90 and the software layer. The software layer may be operable to support and control the hardware layer including network interface 90. Receiving side network hardware abstraction layer 95 is configured to implement wired or wireless communication with network cloud 99, and receiving side network hardware abstraction layer 95 may include an API, inter alia, to control data communications with network cloud 99. Receiving side network hardware abstraction layer 95 may include buffer(s) operable with network interface 90. For example, receiving side network hardware abstraction layer 95 including the hardware layer and the software layer may be configured to implement Ethernet (IEEE 802.3), wireless (IEEE 802.11), Bluetooth, 5G, or other wired or wireless communication with network cloud 99, as would be readily recognized by those of ordinary skill in the art upon study of this disclosure.

Audio output hardware abstraction layer 101, as illustrated in FIG. 2A, includes audio data management module 104, first audio processing module 108, and audio interface 116 that may be configured a software layer and a hardware layer in operable cooperation with one another. The software layer may be operable to support and to control audio data management module 104, first audio processing module 108, second audio processing module 112, and audio interface 116. The software layer of audio output hardware abstraction layer 101 may provide an application programming interface (API) to access audio data management module 104, first audio processing module 108, second audio processing module 112, and audio interface 116. Buffer(s) operable with variously audio data management module 104, first audio processing module 108, second audio processing module 112, and audio interface 116 may be included in audio output hardware abstraction layer 101. The software layer of audio output hardware abstraction layer 101 may be formed as portions of an operating system, firmware, combinations thereof, of a computer, such as computer 97, in various implementations. The hardware layer of audio output hardware abstraction layer 101 includes hardware supporting audio data management module 104, first audio processing module 108, and audio interface 116, and the hardware layer may include hardware supporting the software layer. Portions of a computer, such as computer 97, may form at least portions of the hardware layer. The hardware layer may be configured in the cloud, at least in part, in various implementations.

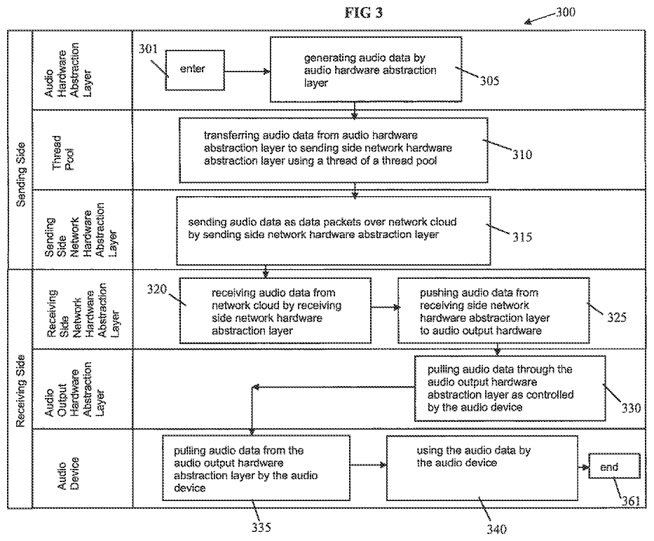

In operation, exemplary audio communication system 10 communicates audio data 15 from audio source 20 on sending side 11 to audio device 120 on receiving side 13 via network cloud 99 in accordance with exemplary method 300 illustrated in FIG. 3. As illustrated in FIG. 3, method 300 is entered at step 301. At step 305, audio source 20, which is included in audio hardware abstraction layer 40 on sending side 11 of audio communication system 10, generates audio data 15.

At step 310, the audio data 15 is transferred from audio hardware abstraction layer 40 to sending side network hardware abstraction layer 60 using a thread of a thread pool.

At step 315, the audio data 15 is sent over network cloud 99 by sending side network hardware abstraction layer 60. The audio data 15 may be transmitted in the form of data packets.

At step 320, the audio data 15 is received from network cloud 99 by receiving side network hardware abstraction layer 95. The audio data 15 may be received from network cloud 99 as data packets.

At step 325, the audio data 15 is pushed to audio output hardware abstraction layer 101 from receiving side network hardware abstraction layer 95.

At step 330, the audio data 15 is pulled through audio output hardware abstraction layer 101 by the audio device 120 so that audio device 120 receives audio data precisely as required by audio device 120. Thus, the audio device 120 controls the flow of audio data 15 through audio output hardware abstraction layer 101, not the reception of the audio data 15 by the receiving side network hardware abstraction layer 95.

At step 335, the audio device 120 pulls the audio data 15 from the audio output hardware abstraction layer 101.

At step 340, the audio device uses the audio data 15. Method 300 terminates at step 361.

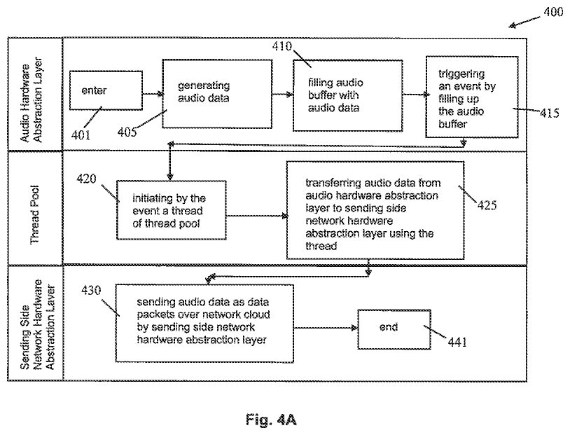

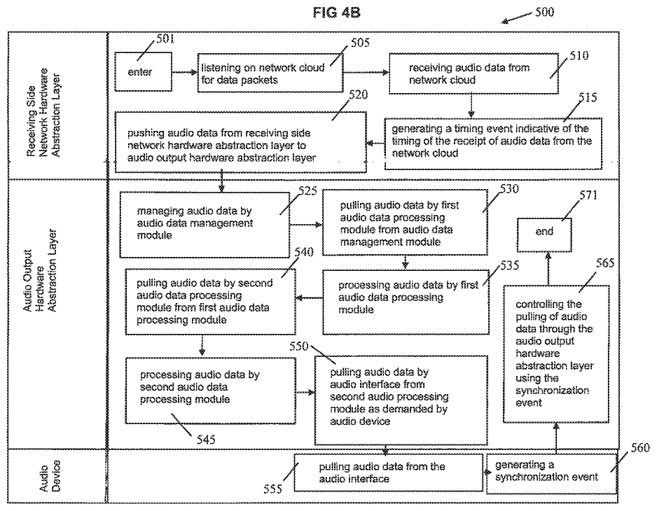

Sending side 11 of audio communication system 10 may implement exemplary method 400 illustrated in FIG. 4A.

As illustrated in FIG. 4A, method 400 is entered at step 401. At step 405, audio data 15 is generated by audio source 20.

The audio buffer 30 is then filled with audio data 15 as the audio data 15 is being generated by audio source 20 at step 410.

At step 415, event 54 is triggered by filling of audio buffer 30.

At step 420, event 54 initiates a thread of thread pool 50.

At step 425, the thread transfers audio data 15 from audio buffer 30 of audio hardware abstraction layer 40 to sending side network hardware abstraction layer 60 that includes network interface 80 and network buffer 70. Using threads of thread pool 50 may increase performance and avoid latency in execution due to frequent creation and destruction of threads for short-lived tasks, e.g., transferring audio data 15 from audio hardware abstraction layer 40 to sending side network hardware abstraction layer 60.

The audio buffer size (e.g., 512, 1024, etc.) of audio buffer 30 may be defined using audio hardware abstraction layer 40 based on time sample (in ms) of the audio and the sample rate. Changing buffer size may cause the timing of event 54 to get upset. The first event 54 may take more time to occur than subsequent events 54 because the audio buffer 30 must be filled to trigger the first event 54 while subsequent events 54 may occur quicker than the first event 54 because the audio buffer is already partly filled, in certain implementations. Audio communication system 10 and method 400 may employ optimized grabbing that uses an optimized buffer size. Want to trigger the event 54 when audio buffer 30 is full thereby grabbing audio data 15 from the audio buffer 30 when the audio buffer 30 is full so there is no overflow. In some implementations, the audio buffer size of audio buffer 30 is fixed and thus cannot be adjusted using audio hardware abstraction layer 40.

At step 430, audio data 15 is sent over network cloud 99 as data packets by sending side network hardware abstraction layer 60. Method 400 terminates at step 441.

In this implementation, thread pool 50 implements a software design that achieves concurrency of execution. Audio source 20 may, for example, sample audio at a fixed rate, and, thus, generate audio data 15 at a fixed rate thereby filling audio buffer 30 at a fixed rate. Although audio data 15 is being generated at the fixed rate, sending side 11 cannot enforce transmission of audio data 15 from sending side network hardware abstraction layer 60 to network cloud 99. Thread pool 50 decouples audio hardware abstraction layer 40 from sending side network hardware abstraction layer 60 in order to match reception of audio data 15 by sending side network hardware abstraction layer 60 with transmission of audio data 15 as data packets over network cloud 99 by sending side network hardware abstraction layer 60. Thus, the generation of audio data 15, which is generally at a fixed rate, is decoupled from the transmission of audio data 15 over network cloud 99, which may vary, in this implementation. Accordingly, the generation of audio data 15 is not impeded by variations in the rate at which the audio data 15 is being sent over network cloud 99 (e.g., the audio source 20 does not need to wait for network cloud 99).

Note that thread pools, such as thread pool 50, are normally used to decouple the receiving (not sending) side of a network, such as receiving side 13 of network cloud 99. In sending side 11 of audio communication system 10, a thread of thread pool 50 is available whenever audio data 15 becomes available in the audio hardware abstraction layer 40. While the current thread is trying to send the audio data 15 over network cloud 99 through sending side network hardware abstraction layer 60, the next thread is waiting to receive data from audio hardware abstraction layer 40. Delays in network cloud 99 may require multiple threads. Sending of audio data 15 from sending side network hardware abstraction layer 60 to network cloud 99 does not block the sending side 11, in this implementation. The audio hardware abstraction layer 40 does not need to wait for transmission of the audio data 15 over the network cloud 99. Accordingly, there is no audio buffer overflow from audio buffer 30 resulting in loss of audio data 15.

Receiving side 13 of audio communication system 10 may implement exemplary method 500 illustrated in FIG. 4B. Exemplary method 500 is entered at step 501. At step 505, receiving side network hardware abstraction layer 95 listens on network cloud 99 for incoming data packets of audio data 15.

At step 510, receiving side network hardware abstraction layer 95 receives incoming data packets of audio data 15 from network cloud 99.

At step 515, a timing event 114 is generated, the timing event 114 being indicative of the timing of receipt of data packets of audio data 15 from network cloud 99 by receiving side network hardware abstraction layer 95 and resultant pushing of the data packets of audio data 15 from receiving side network hardware abstraction layer 95 to audio output hardware abstraction layer 101.

At step 520, audio data 15 is pushed from receiving side network hardware abstraction layer 95 to audio data management module 104. As used herein, a data producer is a module (process) that creates or owns the data. A data consumer is the module (process) that needs the data that the data producer creates or owns. Pushing means that the data producer controls the communication of the data to the data consumer. At step 515, the receiving side network hardware abstraction layer 95, the data producer, controls the communication of the data to the audio data management module 104, the data consumer. For example, receiving side network hardware abstraction layer 95 may push the audio data 15 to the audio data management module 104 as the audio data 15 is produced by being received from network cloud 99.

At step 525, audio data management module 104 manages the data packets, for example, by reassembling data packets, by correcting data packets, by filling data packets, by dropping data packets (if too late), and/or by arranging the data packets in the correct order. The timing event 114 may be used in managing the data packets. Variations in the timing event 114 may be observed that may be indicative of the stability of the input stream of data packets from network cloud 99.

At step 530, first audio processing module 108 pulls audio data 15 from audio data management module 104. Pulling means that the data consumer controls the communication of the data from the data producer. The data consumer, for example, may send a data request to the data producer to initiate communication of the data, and this data request may occur at either regular or irregular time intervals. For example, at step 530, first audio processing module 108, the data consumer, pulls the audio data 15 from the audio data management module 104, the data producer. Accordingly, first audio processing module 108, not audio data management module 104, controls the communication of audio data 15 from audio data management module 104.

At step 535, first audio processing module 108 processes the audio data 15.

At step 540, second audio processing module 112 pulls audio data 15 from first audio processing module 108.

At step 545, second audio processing module 112 processes the audio data 15.

At step 550, audio interface 116 pulls the audio data 15 from second audio processing module 112 as demanded by audio device 120.

At step 555, audio device 120 pulls audio data 15 from audio interface 116.

At step 560, a synchronization event 118 is generated by pulling the audio data 15 from audio interface 116 by audio device 120. The synchronization event 118 indicates the timing at which audio data 15 is being pulled from audio interface 116 by audio device 120. Note that audio data 15 is being pulled from audio interface 116 at a generally constant rate so that synchronization event 118 is being generated at a constant rate, in various implementations.

At step 565, the pulling of audio data 15 through the audio output hardware abstraction layer is controlled using the timing event 114 and the synchronization event 118. For example, using synchronization event 118, audio data management module 104 can then compare the synchronization event 118 (e.g., timing of the pulling of audio data 15 by audio device 120 from audio interface 116) with the timing event 114 (e.g., timing of receiving data packets of audio data 15 from network cloud 99 by receiving side network hardware abstraction layer 95). Audio data management module 104 may use the synchronization event 118 and the timing event 114 to manage buffer sizes and in performing data packet loss concealment which includes, for example, stretching data packets to make the buffer last longer until more data packets become available.

The flow of audio data 15 through audio output hardware abstraction layer 101 is controlled using the timing event 114 and synchronization event 118 to provide audio data 15 to audio device 120 as required by audio device 120. Thus, audio data 15 may be variably received from network cloud 99 by receiving side network hardware abstraction layer 95 and correspondingly variably pushed by receiving side network hardware abstraction layer 95 from receiving side network hardware abstraction layer 95 to audio output hardware abstraction layer 101. Audio output hardware abstraction layer 101 then pulls the audio data 15 therethrough using the timing event 114 and the synchronization event 118 to delivering reassembled audio data 15 to audio device 120 at an essentially constant rate as required by audio device 120.

For example, using synchronization event 118, audio data management module 104 can then compare the synchronization event 118 (e.g., timing of the pulling of audio data 15 by audio device 120 from audio interface 116) with the timing event 114 (e.g., timing of receiving data packets of audio data 15 from network cloud 99 by receiving side network hardware abstraction layer 95). Audio data management module 104 may use the synchronization event 118 and the timing event 114 to manage buffer sizes and in performing data packet loss concealment which includes stretching data packets to make the buffer last longer until more data packets become available.

Accordingly, pulling of audio data 15 by audio device 120 controls the flow of audio data 15 through receiving side 13, not the reception of audio data 15 from network cloud 99. Precisely timing the pulling of audio data 15 by audio device 120 may maintain stability of processing of audio data 15 by audio device 120. For example, pulling of audio data 15 by the audio device 120 at regular time intervals may maintain stability of broadcasting of audio data 15 by the audio device 120 configured as a speaker system for the production of audible sound.

Exemplary method 500 terminates at step 571.

Exemplary receiving side 13 of exemplary audio communication system 10 includes first audio processing module 108 and second audio processing module 112 for purposes of explanation. It should be understood that receiving side 13 may include one or more audio processing modules, such as first audio processing module 108 and second audio processing module 112, in various implementations. The audio processing module(s), such as first audio processing module 108 and second audio processing module 112, may be configured, for example, to implement echo cancelling, low pass filtering, high pass filtering, noise reduction, gain control, resampling, jitter control, and other audio quality improvements, in various implementations. The audio processing module(s) may include a heuristic to detect network fluctuation in advance and compensate for these network fluctuations.

Consider, for example, an implementation wherein first audio processing module 108 is configured to implement echo cancelling. In echo cancelling, a signal is followed by an echo signal (the same as the signal but lower volume). First audio processing module determines the latency between the signal and the echo signal, and uses this latency in cancelling the echo signal. In order to accurately cancel the echo signal, the timing between the signal and the echo signal should remain constant, so that audio data 15 should be pulled at a constant rate by first audio processing module 108 from audio data management module 104. Pulling audio data 15 from audio interface 116 by audio device 120 generates a synchronization event 118 that is communicated from audio interface 116 to audio data management module 104 and is then used to keep the pulling of audio data 15 by first audio processing module 108 from audio data management module 104 constant thereby keeping the timing between the signal and the echo signal constant, per this example.

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 37 C.F.R. § 1.72(b) only. Accordingly, the Abstract is not intended to identify key elements of the methods, systems, and compositions of matter disclosed herein or to delineate the scope thereof. Upon study of this disclosure and the exemplary implementations herein, one of ordinary skill in the art may readily recognize that various changes, modifications and variations can be made thereto without departing from the spirit and scope of the inventions as defined in the following claims.

What is claimed is:

1. A method of communicating audio data, comprising the steps of:
generating audio data indicative of an audio signal by an audio source included in an audio hardware abstraction layer;
generating an event by filling an audio buffer with audio data from the audio source, the audio buffer included in the audio hardware abstraction layer;
triggering a thread of a thread pool by the event, the thread transferring the audio data from the audio hardware abstraction layer to a sending side network hardware abstraction layer, the thread pool decoupling the audio hardware abstraction layer from the sending side network hardware abstraction layer;
sending the audio data as data packets from the sending side network hardware abstraction layer to a network cloud;
receiving data packets incoming from the network cloud by a receiving side network hardware abstraction layer;
pushing data packets from the receiving side network hardware abstraction layer to an audio output hardware abstraction layer;
pulling data packets by an audio device from the audio output hardware abstraction layer, thereby generating a synchronization event; and
using the synchronization event in controlling pulling of data packets through the audio output hardware abstraction module thereby making data packets available for pulling by the audio device.

2. A method of sending audio data, comprising the steps of:
generating audio data by an audio source, an audio hardware abstraction layer comprising the audio source;
filling an audio buffer from the audio source, the audio hardware abstraction layer further comprising the audio buffer;
generating an event by filling of the audio buffer;
transferring the audio data from the audio hardware abstraction layer to a sending side network hardware abstraction layer using a thread of a thread pool, the thread being triggered by the event;
sending the audio data from the sending side network hardware abstraction layer to a network cloud; and
wherein the thread pool decouples the audio hardware abstraction layer from the sending side network hardware abstraction layer thereby decoupling sending the audio data from generating the audio data.

3. A method of receiving audio data, comprising the steps of:
receiving audio data as data packets incoming from a network cloud by a receiving side network hardware abstraction layer, the audio data being indicative of an audio signal;
pushing the audio data from the receiving side network hardware abstraction layer to an audio output hardware abstraction layer;
pulling the audio data by an audio device from the audio output hardware abstraction layer thereby generating a synchronization event; and
using the synchronization event in controlling the pulling of data packets through the audio output hardware abstraction module;
wherein the pulling of data packets from the audio output hardware abstraction module by the audio device controls the flow of data packets through said receiving side not the receiving of data packets from the network cloud by said receiving side.
